(19) United States
(12) Patent Application Publication
(10) Pub. No.: US 2012/0092501 A1
(43) Pub. Date: Apr. 19, 2012

(54) COMPUTING DEVICE AND METHOD FOR ADJUSTING RESOLUTIONS OF INTERNET PROTOCOL CAMERAS

(75) Inventor: CHE-YI CHU, Tu-Cheng (TW)

(73) Assignee: HON HAI PRECISION INDUSTRY CO., LTD., Tu-Cheng (TW)

(21) Appl. No.: 13/155,308

(22) Filed: Jun. 7, 2011

(30) Foreign Application Priority Data
Oct. 13, 2010 (TW) 99134971

(51) Int. Cl. H04N 7/18

(52) U.S. Cl. 348/159; 348/E07.085

(57) ABSTRACT

An electronic device connects with one or more Internet Protocol (IP) cameras via a network. The electronic device receives a first real-time image of a monitored area captured by an IP camera at a first resolution, compares the first real-time image with an initial image of the monitored area, to determine if suspicious activity appears in the monitored area. If suspicious activity appears in the monitored area, the electronic device generates and sends a control command to the IP camera via the network, to automatically adjust the resolution of the IP camera from the first resolution to a second resolution.

### BACKGROUND

1. Technical Field

Embodiments of the present disclosure relate to network device controlling systems and methods, and more particularly, to a computing device and a method for adjusting resolutions of Internet Protocol (IP) cameras.

2. Description of related art

Internet Protocol (IP) cameras are stand-alone devices which allow users to view real-time, full motion videos of remote monitored areas. Presently, each IP camera in a network records video data of a monitored area with a fixed resolution. The recorded video data from all IP cameras distributed in a network are often transmitted and are stored in a monitor computer via the network. One problem is that, if the fixed resolution of an IP camera is too high, the video data recorded by the IP camera may occupy a large amount of storage space of the monitor computer. However, if the fixed resolution of the IP camera is too low, images captured by the IP camera may not be clear enough to identify if a suspicious element appears in the monitored area.

### BRIEF DESCRIPTION OF THE DRAWINGS

FIG. 1 is a block diagram of one embodiment of a computing device comprising a resolution adjustment system.

FIG. 2 is a block diagram of one embodiment of function modules of the resolution adjustment system of FIG. 1.

FIG. 3A and FIG. 3B are a flowchart of one embodiment of a method for adjusting resolutions of IP cameras.

FIG. 4 and FIG. 5 are example of images of a monitored area captured at different time by an IP camera.

### DETAILED DESCRIPTION

The disclosure, including the accompanying drawings in which like references indicate similar elements, is illustrated by way of examples and not by way of limitation. It should be noted that references to “an” or “one” embodiment in this disclosure are not necessarily to the same embodiment, and such references mean at least one.

In general, the word “module,” as used hereinafter, refers to logic embodied in hardware or firmware, or to a collection of software instructions, written in a programming language, such as, for example, Java, C, or Assembly. One or more software instructions in the modules may be embedded in firmware. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

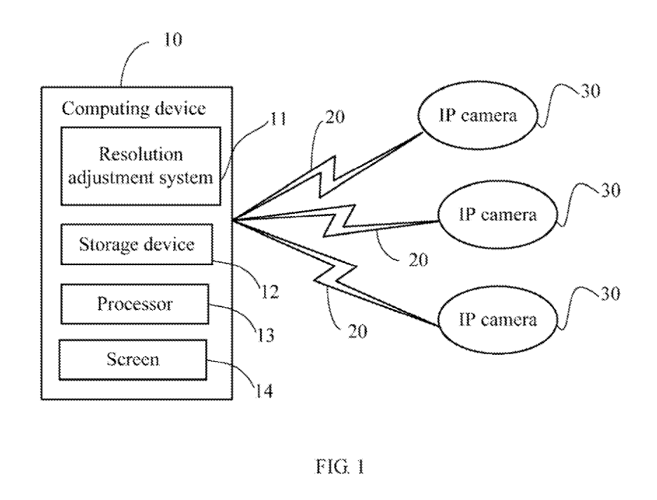

FIG. 1 is a block diagram of one embodiment of a computing device 10. The computing device 10 includes a resolution adjustment system 11, a storage device 12, a processor 13, and a screen 14. The computing device 10 may be a computer or a server. One or more Internet Protocol (IP) cameras 30 are connected to the computing device 10 via a network 20. Each IP camera 30 records video data of a monitored area, and transmits the video data to the electronic device 10 via the network 20. The computing device 10 stores the video data in the storage device 12, and displays the video data on the screen 14 for users to view. The resolution adjustment system 11 analyzes the video data to determine if suspicious activity appears in the monitored area, and adjusts a resolution of the IP camera 30 if suspicious activity appears in the monitored area, so that the IP camera 30 records video data with a lower resolution when no suspicious activity appears in the monitored area, and records video data with a higher resolution when suspicious activity appears in the monitored area.

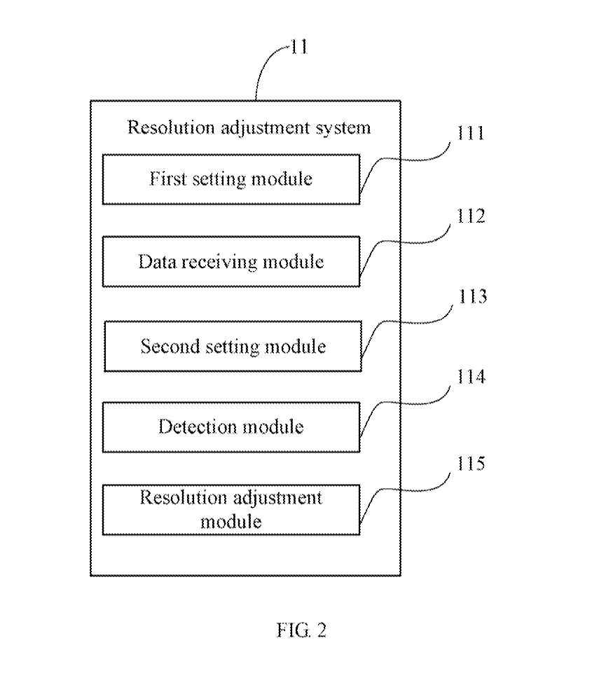

As shown in FIG. 2, the system 11 includes a plurality of function modules. The function modules may comprise computerized code in the form of one or more programs that are stored in the storage device 12. The computerized code includes instructions that are executed by the processor 13 to provide above-mentioned functions of the system 11. In one embodiment, the system 11 includes a first setting module 111, a data receiving module 112, a second setting module 113, a detection module 114, and a resolution adjustment module 115.

The first setting module 111 is operable to set a first resolution of an IP camera 30 for capturing images of the monitored area. For example, the first resolution may be set as 560 pixels×420 pixels.

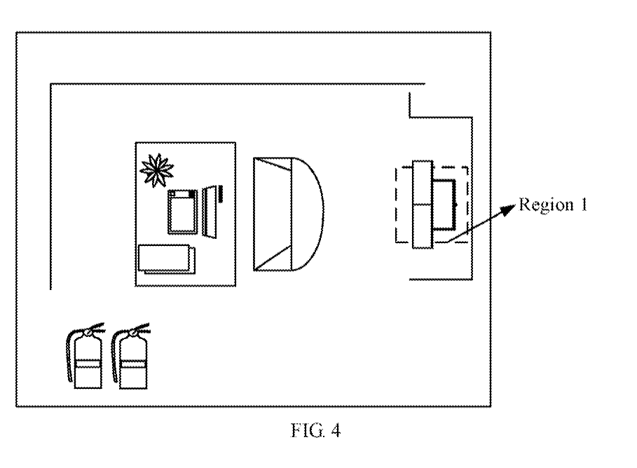

The data receiving module 112 is operable to receive an initial image of the monitored area captured by the IP camera at the first resolution. For example, the data receiving module 112 receives the initial image, which is captured at the first resolution of 560 pixel×420 pixel, as shown in FIG. 4.

The second setting module 113 is operable to set a monitoring region of the monitored area in the initial image, and set an alert level of an image deviation for the monitoring region. For example, a “region 1” in the initial image shown in FIG. 4 may be set as the monitoring region, and an alert level may be set as 25%. In one embodiment, the image deviation is a difference between the monitoring region in a real-time image of the monitored area and the monitoring region in the initial image.

For example, the image deviation may be computed as follows: dividing the monitoring region into predetermined equal divisions (e.g. 20 equal divisions), if no deviations occur in the monitoring region in the real-time image compared to the initial image, the image deviation of the later captured image is: 0/20=0%; if deviation occurs in two equal divisions of the 20 equal divisions, the image deviation of the real-time image is: 2/20=10%. The alert level is a threshold value for triggering adjusting the resolution of the IP camera 30.

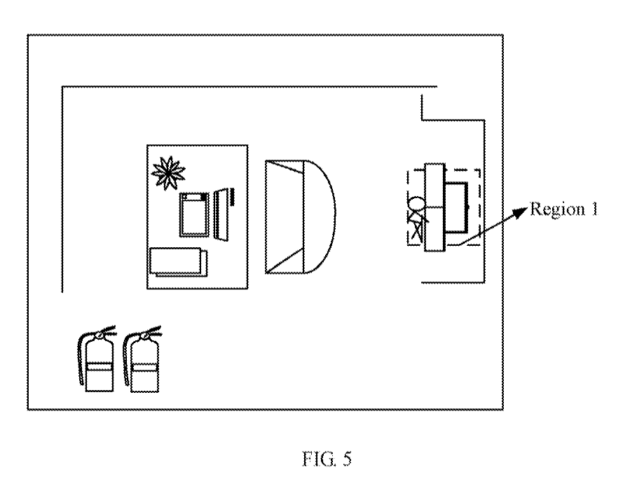

The data receiving module 112 is further operable to receive a first real-time image of the monitored area captured by the IP camera 30 at the first resolution. In one embodiment, all images captured by the IP camera 30 at the first resolution is regarded as first real-time images. For example, the IP camera 30 may capture the first real-time image as shown in FIG. 5 at the first resolution of 560 pixels×420 pixels.

The detection module 114 is operable to compare the first real-time image with the initial image, determine whether a suspicious activity appears in the monitored area by determining whether the image deviation of the first real-time image exceeds the alert level. For example, if the image deviation of the monitoring region in the first real-time image exceeds the alert level 25%, the detection module 114 determines that a suspicious activity appears in the monitoring region. The suspicious activity may be suspects, or abnormal events such as fire.

The resolution adjustment module 115 is operable to generate and send a first control command to the IP camera 30 via the network 20, to automatically adjust the resolution of the IP camera 30 from the first resolution to a second resolution, in response that a suspicious activity appears in the monitored area. The IP camera 30 uses the second resolution to capture second real-time images of the monitored area. For example, if a suspicious activity appears in the monitoring region, the resolution adjustment module 115 may adjust the resolution of the IP camera 30 from 560 pixels×420 pixels (lower resolution) to 720 pixels×540 pixels (higher resolution) according to the first control command, so that the IP camera 30 captures clearer images of the monitored area.

The detection module 114 is further operable to compare a second real-time image with the initial image, and determine whether the suspicious activity has disappeared from the monitored area by determining whether the image deviation of the second real-time image exceeds the alert level. For example, if the image deviation of the second real-time image compared to the initial image does not exceed the alert level, the detection module 114 determines that the suspicious activity has disappeared from the monitored area.

The resolution adjustment module 115 is further operable to generate and send a second control command to the IP camera 30 via the network 20, to automatically adjust the resolution of the IP camera 30 from the second resolution to the first resolution, in response that the suspicious activity has disappeared from the monitored area. Then, the IP camera 30 uses the first resolution to capture first real-time images of the monitored area, which occupy less storage space of the storage device 12. For example, if the suspicious activity has disappeared from the monitoring region, the resolution adjustment module 115 may adjust the resolution of the IP camera 30 from 720 pixels×540 pixels to 560 pixels×420 pixels according to the second control command.

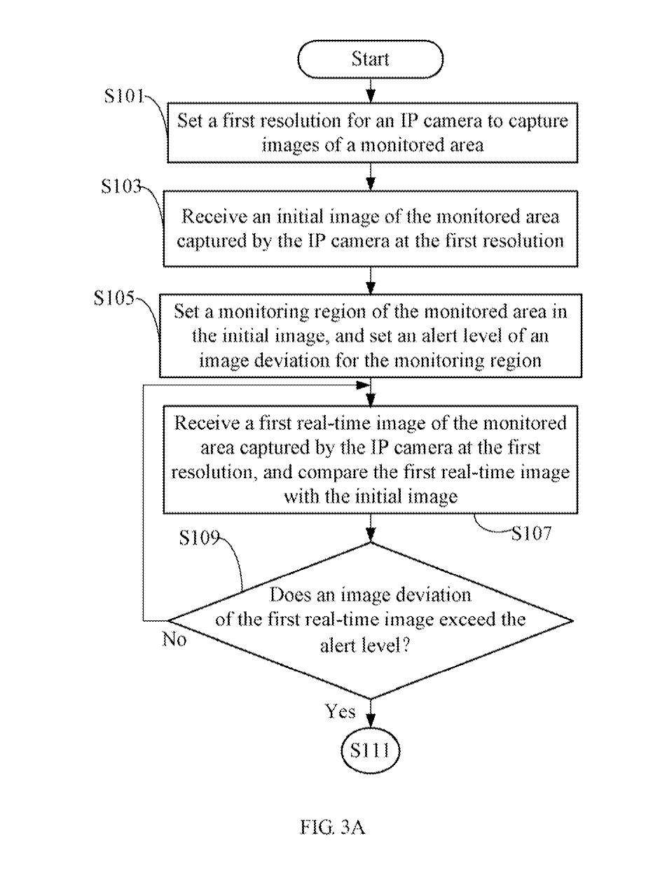

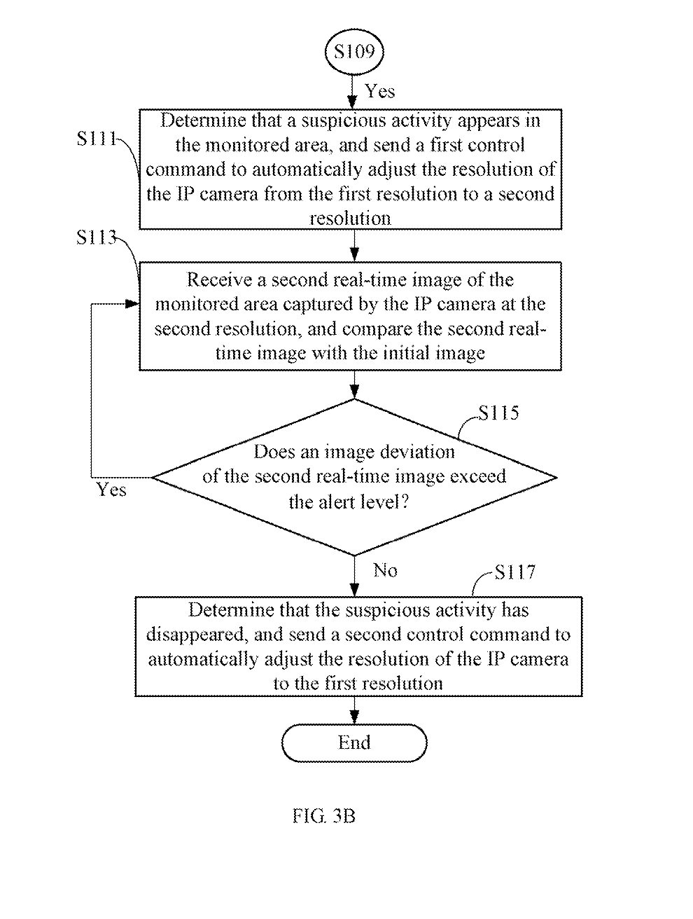

FIG. 3A and FIG. 3B are a flowchart of one embodiment of a method for adjusting resolutions of IP cameras 30. Depending on the embodiment, additional blocks may be added, others removed, and the ordering of the blocks may be changed.

In block S101, the first setting module 111 sets a first resolution of an IP camera 30 for capturing images of the monitored area. For example, the first resolution may be set as 560 pixels×420 pixels. The first setting module 111 may set the same first resolution for all IP cameras 30 in the network 20, or set unique first resolution for each IP camera 30 in the network 20.

In block S103, the IP camera captures an initial image of the monitored area at the first resolution, the data receiving module 112 receives the initial image and stores the initial image in the storage device 12. For example, the initial image shown in FIG. 4 may be captured by the IP camera 30 at the first resolution of 560 pixels×420 pixels.

In block S105, the second setting module 113 sets a monitoring region of the monitored area in the initial image, and sets an alert level of an image deviation for the motion detection region. For example, a “region 1” in the initial image shown in FIG. 4 may be set as the monitoring region, and an alert level may be set as 25%. In one embodiment, the image deviation is a difference between the monitoring region in a real-time image of the monitored area and the monitoring region in the initial image. The alert level is a threshold value for triggering adjusting the resolution of the IP camera 30.

In block S107, the data receiving module 112 receives a first real-time image of the monitored area captured by the IP camera at the first resolution. For example, the IP camera 30 may capture a first image as shown in FIG. 5 at the first resolution of 560 pixels×420 pixels. The detection module 114 compares the first real-time image with the initial image, to determine an image deviation of the first real-time image.

In block S109, the detection module 114 determines whether a suspicious activity appears in the monitored area by determining whether the image deviation of the first real-time image exceeds the alert level. If the image deviation of the monitoring region in the first real-time image does not exceed the alert level (such as 25%), the procedure returns to block S107. If the image deviation of the monitoring region in the first real-time image exceeds the alert level (such as 25%), the procedure goes to block S111.

In block S111, the detection module 114 determines that a suspicious activity appears in the monitoring region, and the resolution adjustment module 115 generates and sends a first control command to the IP camera 30 via the network 20, to automatically adjust the resolution of the IP camera 30 from the first resolution to a second resolution. For example, if a suspicious activity appears in the monitoring region, the resolution adjustment module 115 may adjust the resolution of the IP camera 30 from 560 pixels×420 pixels to 720 pixels×540 pixels, so that the IP camera 30 captures clear images of the monitored area. The suspicious activity may be suspects, or abnormal events such as fire.

In block S113, the IP camera 30 captures a second real-time image of the monitored area at the second resolution, the data receiving module 112 receives and stores the second real-time image in the storage device 12. The detection module 114 compares the second real-time image with the initial image, to determine an image deviation of the second real-time image.

In block S115, the detection module 114 determines whether the suspicious activity has disappeared from the monitored area by determining whether the image deviation of the second real-time image exceeds the alert level. If the image deviation of the second real-time image compared to the initial image still exceeds the alert level (such as 25%), the detection module 114 determines that the suspicious activity has not disappeared, the procedure goes to block S113. Otherwise, if the image deviation of the second real-time image compared to the initial image does not exceed the alert level (such as 25%), the procedure goes to block S117.

In block S117, the detection module 114 determines that the suspicious activity has disappeared from the monitored area, and the resolution adjustment module 115 generates and sends a second control command to the IP camera 30 via the network 20, to automatically adjust the resolution of the IP camera 30 from the second resolution to the first resolution. Then, the IP camera 30 uses the first resolution to capture first real-time images of the monitored area, which occupy less storage space of the storage device 12. For example, if the suspicious activity has disappeared from the monitoring region, the resolution adjustment module 115 may adjust the resolution of the IP camera 30 from 720 pixels×540 pixels to 560 pixels×420 pixels.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computer-based method for adjusting resolutions of Internet Protocol (IP) cameras, the method comprising:
setting a first resolution for an IP camera connected to an electronic device via a network;
receiving an initial image of a monitored area captured by the IP camera at the first resolution via the network;
setting a monitoring region of the monitored area in the initial image, and setting an alert level of an image deviation for the monitoring region;
receiving a first real-time image of the monitored area captured by the IP camera at the first resolution;
comparing the first real-time image with the initial image, and determining whether a suspicious activity appears in the monitored area by determining whether the image deviation of the first real-time image exceeds the alert level; and
sending a first control command to the IP camera via the network, to automatically adjust the resolution of the IP camera from the first resolution to a second resolution, in response that a suspicious activity appears in the monitored area.

2. The method as claimed in claim 1, wherein if the image deviation of the monitoring region in the first real-time image compared to the initial image exceeds the alert level, a determination is made that the suspicious activity appears in the monitoring region.

3. The method as claimed in claim 1, further comprising:
storing the initial image and the first real-time image in a storage device of the electronic device.

4. The method as claimed in claim 1, wherein the image deviation is a difference between the monitoring region in a real-time image of the monitored area and the monitoring region in the initial image.

5. The method as claimed in claim 1, further comprising:
receiving a second real-time image of the monitored area captured by the IP camera at the second resolution;
comparing the second real-time image with the initial image, and determining whether the suspicious activity has disappeared from the monitored area by determining whether the image deviation of the second real-time image exceeds the alert level; and
sending a second control command to the IP camera via the network, to automatically adjust the resolution of the IP camera from the second resolution to the first resolution, in response that the suspicious activity has disappeared from the monitored area.

6. The method as claimed in claim 5, wherein if the image deviation of the monitoring region in the second real-time image compared to the initial image does not exceed the alert level, a determination is made that the suspicious activity has disappeared from the monitoring region.

7. The method as claimed in claim 5, further comprising:
storing the second real-time image in a storage device of the electronic device.

8. A computing device, comprising:
a storage device;
at least one processor; and
one or more programs, which are stored in the storage device and executable by the at least one processor, the one or more programs comprising:
a first setting module to set a first resolution for an Internet Protocol (IP) camera connected to an electronic device via a network;
a data receiving module to receive an initial image of a monitored area captured by the IP camera at the first resolution via the network;
a second setting module to set a monitoring region of the monitored area in the initial image, and set an alert level of an image deviation for the monitoring region;
the data receiving module further to receive a first real-time image of the monitored area captured by the IP camera at the first resolution;
a detection module to compare the first real-time image with the initial image, and determine whether a suspicious activity appears in the monitored area by determining whether the image deviation of the first real-time image exceeds the alert level; and
a resolution adjustment module to send a first control command to the IP camera via the network, to automatically adjust resolution of the IP camera from the first resolution to a second resolution, in response that a suspicious activity appears in the monitored area.

9. The computing device as claimed in claim 8, wherein the detection module determines that the suspicious activity appears in the monitoring region, if the image deviation of the monitoring region in the first real-time image compared to the initial image exceeds the alert level.

10. The computing device as claimed in 8, wherein the image deviation is a difference between the monitoring region in a real-time image of the monitored area and the monitoring region in the initial image.

11. The computing device as claimed in 8, wherein:
the data receiving module is further to receive a second real-time image of the monitored area captured by the IP camera at the second resolution;
the detection module is further to compare the second real-time image with the initial image, and determine whether the suspicious activity has disappeared from the monitored area by determining whether the image deviation of the second real-time image exceeds the alert level; and
the resolution adjustment module is further to send a second control command to the IP camera via the network, to automatically adjust the resolution of the IP camera from the second resolution to the first resolution, in response that the suspicious activity has disappeared from the monitored area.

12. The computing device as claimed in 12, wherein the detection module determines that the suspicious activity has disappeared from the monitoring region, if the image deviation of the monitoring region in the second real-time image compared to the initial image does not exceed the alert level.

13. The computing device as claimed in 12, wherein the initial image, the first real-time image, and the second real-time image are stored in the storage device.

14. A non-transitory computer readable medium storing a set of instructions, the set of instructions capable of being executed by a processor of a computing device to perform a method for adjusting resolutions of Internet Protocol (IP) cameras, the method comprising:
setting a first resolution for an IP camera connected to an electronic device via a network;
receiving an initial image of a monitored area captured by the IP camera at the first resolution via the network;
setting a monitoring region of the monitored area in the initial image, and setting an alert level of an image deviation for the monitoring region;
receiving a first real-time image of the monitored area captured by the IP camera at the first resolution;
comparing the first real-time image with the initial image, and determining whether a suspicious activity appears in the monitored area by determining whether the image deviation of the first real-time image exceeds the alert level; and sending a first control command to the IP camera via the network, to automatically adjust resolution of the IP camera from the first resolution to a second resolution, in response that a suspicious activity appears in the monitored area.

15. The non-transitory computer readable medium as claimed in claim 14, wherein if the image deviation of the monitoring region in the first real-time image compared to the initial image exceeds the alert level, a determination is made that the suspicious activity appears in the monitoring region.

16. The non-transitory computer readable medium as claimed in claim 14, wherein the method further comprises:
storing the initial image and the first real-time image in a storage device of the electronic device.

17. The non-transitory computer readable medium as claimed in claim 14, wherein the image deviation is a difference between the monitoring region in a real-time image of the monitored area and the monitoring region in the initial image.

18. The non-transitory computer readable medium as claimed in claim 14, wherein the method further comprises:
receiving a second real-time image of the monitored area captured by the IP camera at the second resolution;
comparing the second real-time image with the initial image, and determining whether the suspicious activity has disappeared from the monitored area by determining whether the image deviation of the second real-time image exceeds the alert level; and
sending a second control command to the IP camera via the network, to automatically adjust the resolution of the IP camera from the second resolution to the first resolution, in response that suspicious activity has disappeared from the monitored area.

19. The non-transitory computer readable medium as claimed in claim 18, wherein if the image deviation of the monitoring region in the second real-time image compared to the initial image does not exceed the alert level, a determination is made that the suspicious activity has disappeared from the monitoring region.

20. The non-transitory computer readable medium as claimed in claim 18, wherein the method further comprises:
storing the second real-time image in a storage device of the electronic device.
